(19) United States
(12) Patent Application Publication
(10) Pub. No.: US 2002/0071989 A1
(43) Pub. Date: Jun. 13, 2002

(54) Packaging systems and methods for thin film solid state batteries

(76) Inventors: Surrenda K. Verma, Atlanta, GA (US); Eleston Maxie JR., Kennesaw, GA (US); Richard C. Breitkopf, Atlanta, GA (US); Ji-Guang Zhang, Marietta, GA (US)

Correspondence Address: Edwina Thomas Washington, EXCELLATRON SOLID STATE, LLC, 1640 Roswell Street, Suite J, Smyrna, GA, 30080, US

(21) Appl. No.: 09/733,285

(22) Filed: Dec. 8, 2000

(51) Int. Cl. H01M 2/02

(52) U.S. Cl. 429/176; 29/623.2; 29/623.5; 429/162

(57) ABSTRACT

A thin film battery having a protective package that provides a heat-resistant, hermetic seal for the thin film battery. A thin film battery includes thin film layers of components such as a cathode current collector, a cathode, an electrolyte, an anode, and an anode current collector built up on a substrate. Layers of dielectric material are positioned over the thin film battery. Suitable dielectric materials include aluminum oxide, silicon dioxide, silicon nitride, silicon carbide, tantalum oxide, diamond, and diamond-like-carbon. The dielectric materials are annealed. A layer of epoxy is positioned completely over all layers of the thin film battery and cured under ultraviolet light. Finally, the epoxy is annealed. The resultant thin film battery has a package that provides protection from the atmosphere, high temperatures, undesirable gases and can withstand processes utilized in the semiconductor and other industries to produce printed circuit boards with surface mounted thin film batteries.

### FIELD OF THE INVENTION

This invention relates to thin film battery construction, and more particularly, heat-resistant packaging systems and methods for thin film solid state batteries.

### BACKGROUND OF THE INVENTION

Penetration of oxygen, nitrogen, carbon dioxide and moisture into energy storage devices, in particular, thin film batteries is a very serious problem. Lithium, a material used in the fabrication of thin film batteries is highly unstable in the presence of these materials and reacts rapidly upon exposure to oxygen, nitrogen, carbon dioxide and water vapor. Other electrode materials, including a cathode and anode, are also unstable in the presence of water vapor and other gases. Diffusion of undesirable gases and moisture into the cells of the thin film battery renders the cells ineffective. Thus, the anode of a thin film battery, including lithium metal, metal oxide, metal nitride lithium alloy, etc. reacts in an undesirable manner upon exposure to such elements if the anode is not suitably protected.

Other components of a thin film battery, such as a lithium based electrolyte and cathode films, also require protection from exposure to air although these components are commonly not as reactive as thin metal anode films. It is therefore necessary to develop a packaging system that satisfactorily protects the battery components from exposure to air, water and submersion of the completed thin film battery in water.

Generally, for electronic applications, components are surface mounted onto a printed circuit board using a solder paste. The printed circuit board having components thereon passes through a high temperature solder reflow process to melt the solder paste. A high temperature of approximately 260° C., is used in the solder reflow process and the device is subsequent rinsed in warm water. The melted solder on the printed circuit board eventually solidifies establishing electrical connections.

The solder reflow process is devastating to the thin film batteries containing lithium if the thin film battery is not properly protected by a suitable package. The cells experience drastic deterioration in performance and the cells substantially physically degrade. Without a hermetic packaging for thin film batteries, they cannot be assembled using well known and established processes commonly used in the semiconductor and other industries to assemble and test printed circuit boards.

In the past packaging systems for thin film batteries have been devised which included a shield which overlays the active components of the battery. These shields have been made of ceramic material, a metallic material, and a combination of ceramic and metallic material. The construction of thin film batteries however has proven to be quite difficult to produce with an appropriate barrier as gas pockets have been captured between the anode and the protective layer during construction.

Another thin film battery packaging system has been devised wherein alternating layers of parylene and titanium are laid over the active components of the battery. The alternating layers are provided to restrict the continuation of pinholes formed in the layers during construction. This method of producing a protective layer is not production worthy in that parylene cannot be deposited over selective areas and it only provides a protective layer which remains effective about a month.

Accordingly, a need exists for systems and methods of packaging thin film batteries, especially lithium based thin film batteries that protects the battery from undesirable gases, moisture, high temperature exposure and protects the battery from deterioration when the battery is subjected to assembly and testing procedures widely used in the semiconductor industry and other industries.

### SUMMARY OF THE INVENTION

Systems and methods for providing a thin film battery having a heat-resistant, hermetic sealed protective package. The thin film battery including components, for instance a cathode, an electrolyte and an anode, built up on a substrate. A protective coating over the thin film battery is provided by inclusion of a layer of aluminum oxide over an upper layer of the thin film battery and a layer of silicon dioxide on top of the layer of aluminum oxide. Epoxy is deposited over the entire thin film battery and cured under ultraviolet light. Finally, the epoxy is annealed. The resultant thin film battery has a package that provides protection from the atmosphere, undesirable gases and can withstand processes utilized in the semiconductor and other industries to produce printed circuit boards with surface mounted thin film batteries.

This invention accordingly aims to achieve at least one, more or combinations of the following objectives:

To provide systems and methods for a thin film battery having a heat-resistant hermetically sealed package.

To provide systems and methods for packaging a thin film battery that can sustain the rigors of a solder reflow process.

To provide systems and methods for packaging a thin film battery that can be submerged in heated degreaser and water without degradation.

To provide systems and methods for packaging a thin film battery that withstands atmospheric gaseous elements over the long term.

To provide systems and methods for packaging a thin film battery that is heat-resistant up to about 300° C.

Other objects, advantages and features of the systems and methods of this invention will be set forth in part in the description which follows and in part will be obvious from the description or may be learned by practice of the invention. The objects, advantages and features of this invention will be realized and attained by means of the elements and combinations particularly pointed out in the claims.

### BRIEF DESCRIPTION OF THE DRAWINGS

FIG. 1 is a schematic cross sectional view of a thin film battery made in accordance with the systems and methods of this invention.

FIG. 2 is a schematic cross sectional view of a thin film battery having a protective coating that is heat-resistant and hermetically seals the thin film battery.

FIG. 3 is a flow diagram of the process to produce a thin film battery having a protective coating in accordance with this invention.

FIG. 4 is a graph of performance of a thin film battery with only an epoxy coating displaying a significant reduction in capacity when an unprotected thin film battery is exposed to temperature and water.

FIG. 5 is a graph of performance of a thin film battery having a protective coating made in accordance with the systems and methods of this invention displaying the performance results of the protected thin film battery wherein upon exposure to temperature and moisture the capacity does not deteriorate.

### DETAILED DESCRIPTION

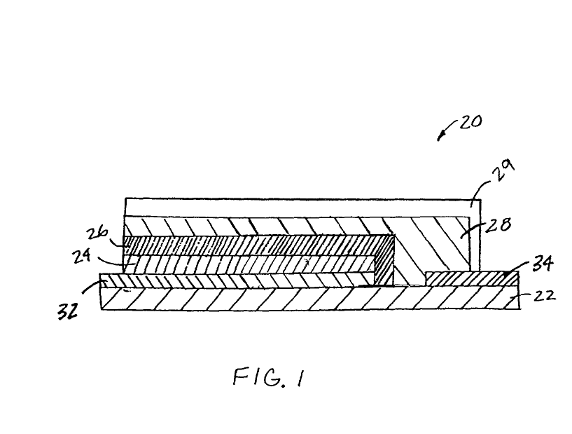

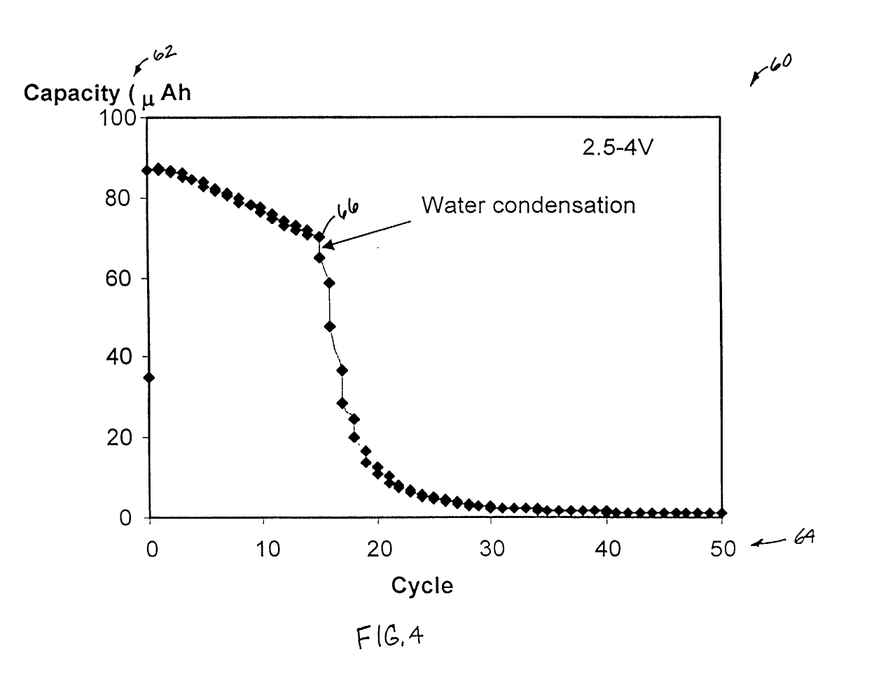

Reference will now be made in detail to preferred embodiments of the invention, examples of which are illustrated in the accompanying drawings. FIGS. 1-3 and 5 depict various aspects of a thin film battery having a protective package. FIG. 4 depicts test results for an unprotected thin film battery upon exposure to heat and water.

FIG. 1 shows a thin film battery 20 that includes components that have been built up onto a substrate 22. The battery includes a cathode 24, an electrolyte 26 and an anode 28, wherein each component is produced by a film deposited in a predetermined fashion upon the substrate 22.

The substrate underlying the battery 20 may encompass glass, alumina, sapphire, metal, silicon or various semiconductor or polymer materials. To enable electrical power to be withdrawn from the battery 20, two current collector films 32 and 34 are deposited upon the substrate 22, and then the cathode film 24 is deposited upon the collector 32. The current collector films 32 and 34 are separated from each other as shown in FIG. 1.

The electrolyte film 26 is deposited in place so as to cover the cathode film 24. Preferably, the electrolyte 26 is an amorphous lithium phosphorus oxynitride having the composition LiₓPO_{y}N_{z}, for instance Li_{2.9}PO_{3 3}N_{0.46}. The anode 28 encompasses lithium, tin nitride (ZnN) and other lithium insertion compounds and is deposited upon the previously formed films 24, 26 and 28 so as to directly overlie a substantial portion of the electrolyte 26. The current collector 29 is deposited on top of anode 28.

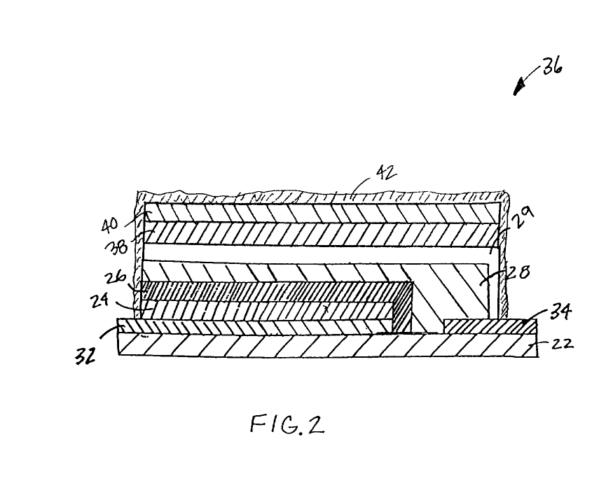

FIG. 2 shows a schematic cross sectional view of a thin film battery 20 having a protective coating that is heat-resistant and hermetically seals the thin film battery. The protective coating layers include thin films of any of the two dielectric materials, such as, for instance, aluminum oxide (Al₂O₃), silicon dioxide (SiO₂), silicon nitride (Si₃N₄), silicon carbide (SiC), tantalum oxide (Ta₂O₅), diamond, and diamond-like-carbon (DLC).

For illustrative purposes, the FIG. 2 shows a thin film battery 20 includes a layer of aluminum oxide (Al₂O₃) 38 that overlies and covers the entire top surface of the current collector 29. A layer of silicon dioxide (SiO₂) 40 is positioned over the layer of aluminum oxide 38. The layers of aluminum oxide 38 and silicon dioxide 40 are preferably positioned onto the thin film battery 20 by reactively sputtered thin films of aluminum oxide and silicon dioxide. Sputtering is an electro-physical process in which a target (rendered cathodic) is bombarded with highly energetic positive ions which by transferring their energy, cause ejection of particles from the target. The sputtered particles deposit as thin films on substrates placed on anodic or grounded holders.

Reactive sputtering is a variation of sputtering. In a reactive sputtering process, a reactive gas is introduced along with an inert argon to form a plasma. Reactive sputtering uses a combined physical, electrical and chemical process. The reactive gas becomes activated and chemically combines with the atoms that are sputtered from the target to form a new compound. Generally, the amount of reactive gas used is small compared with that of the inert gas. By varying the ratio of reactive gas to inert gas, films ranging in properties from almost a metal to semiconductor, insulator or resistor can be produced. Two widely used reactive gases are oxygen (i.e. producing oxides of metals) and nitrogen (i.e. producing nitrides of metals).

Radio frequency (RF) sputtering involves the target being subjected alternatively to positive ion and electron bombardment. RF sputtering is a versatile process that in addition to metals and alloys, RF sputtering can be used to deposit dielectric materials at relatively low temperature and pressure.

Preferably, any of the stoichiometric oxides and nitrides are RF sputtered in argon under partial pressure of oxygen and nitrogen respectively. Diamond and diamond-like-carbon coatings can be processed by a plasma enhanced chemical vapor deposition (PECVD) process. In a PECVD process plasma (or glow discharge) is generated by the application of a DC or radio frequency field to a low pressure gas, thereby creating free electrons within the discharge region. The electrons gain energy from the electric field so that when they collide with gas molecules, gas-phase dissociation and ionization of the reactant gases occurs. The energetic species, predominantly radicals are then adsorbed on the substrate surface. These radicals tend to have a high sticking coefficient, and also appear to migrate easily along the surface after adsorption. These two factors lead to excellent film conformality. PECVD provides a method of depositing films on substrates that do not have thermal stability to accept coatings by other methods, such as chemical vapor deposition (CVD), for the formation of nitride, oxide and carbide of silicon.

Deposition of diamond and diamond-like-carbon coatings by PECVD process involves excitation of mixtures of hydrogen, hydrocarbon, and inert gases either in a DC or RF glow discharge. In both instances, a plasma is generated, and carbon atoms are liberated by decomposition of the hydrocarbon gas. The free carbon atoms in the plasma have enough energy to permit tetragonal (diamond) bonding, but the condensed films produced usually are mixtures of tetragonally-bonded carbon (diamond), trigonally-bonded carbon (graphite) and other allotropic crystalline forms of carbon.

After coating the battery cells with any of the protective coatings, the battery cells having the coating are annealed at about 260° for about six minutes.

Epoxy 42 covers the layer of silicon dioxide 40 and all exposed portions of the thin film battery 20. A suitable epoxy 42 should be a non-acidic liquid epoxy. A suitable epoxy is available from MLT/Micro-Lite Technology Corporation of Mesa, Ariz. The epoxy 42 is cured by use of an ultraviolet light. The cured epoxy 42 is annealed at approximately 260° C. for about five minutes. Preferably, each layer 38, 40 and 42 is between about 0.1 to 5 microns thick. The inert inorganic coatings provide the barrier to atmospheric conditions, heat and moisture, while the epoxy layer seals any pin-holes in the inorganic dielectric layers and provides a durable protection to the underlying inorganic layers.

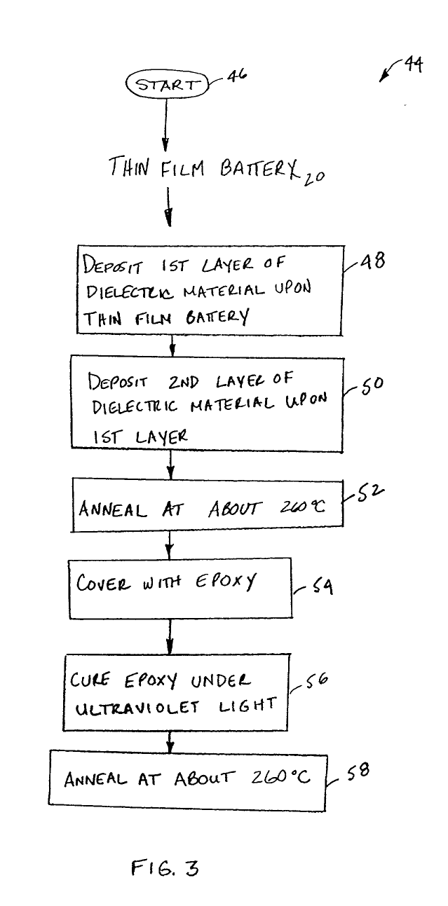

FIG. 3 shows a flow diagram 44 of the process to produce a thin film battery having a protective coating in accordance with this invention. At 46 the process begins with a thin film battery 20 such as the one shown in FIG. 1. At 48, a layer of dielectric material is deposited upon the thin film battery 20. A second layer of dielectric material is deposited upon the first layer at 50. At 52, the thin film battery 20 having the multilayers of dielectric material deposited thereon is annealed at about 260° for about six minutes. At 54 the entire composite is covered with epoxy. The epoxy is cured under ultraviolet light at 56. The cured epoxy is annealed at about 260° C. for about five minutes at 58.

It should be understood that this invention also includes the use of non-ultraviolet light curable epoxies but is not intended to be limited to such as other types of epoxies may be utilized in practicing this invention.

FIG. 4 shows a graph 60 of performance of a thin film battery with only an epoxy coating. The graph 60 shows a plot of cell charge/discharge capacity 62 versus cycles 64. The thin film battery in this example encompasses a LiCoO₂/Sn₃N₄ cell. At about 18 cycles 66, the thin film battery was exposed to water condensation. The capacity quickly dropped from about 70 μAh to zero μAh. As shown in FIG. 4, exposure to water caused the unprotected thin film battery to lose a significant amount of, if not all, its capacity.

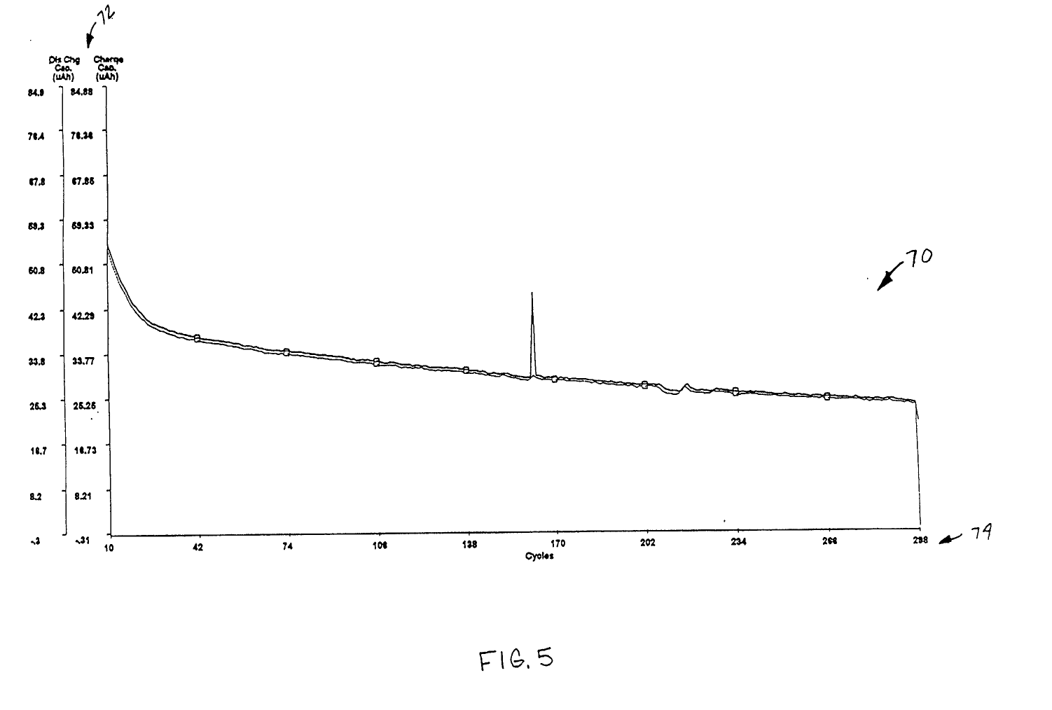

FIG. 5 shows a graph 70 of performance of a thin film battery having a protective coating described in this invention. The graph 70 shows a plot of cell charge/discharge capacity 72 versus cycles 74. In this example, the thin film battery encompasses a LiCoO₂/Sn₃N₄ cell. The graph 70 shows 298 cycles however, the thin film battery is not limited to only 298 cycles and can be cycled for a considerably longer period. Unlike the conventionally protected thin film battery shown in FIG. 4, the thin film battery cell having a protective coating of this invention does not experience a swift drop in capacity when exposed to water or heat. In experiments on the thin film battery of FIG. 5, the battery was immersed in water at about 70° C. for about three minutes and cycled at about 25° C. As shown in FIG. 5, exposing a protected thin film battery having a protective coating made in accordance with the systems and methods of this invention eliminates the significant performance degradation when exposed to temperature, gases and liquids that is experienced in the unprotected thin film battery shown in FIG. 4.

In an alternative embodiment, instead of using epoxy to cover the thin film battery 20 having protective coatings, glow discharge (or PECVD) polymerized silicon containing hydrophobic films can be utilized as a sealant.

An advantage of this invention is that the composite protective coatings render the thin film battery impervious to heat, gases and liquids. The protected thin film battery of this invention can withstand high temperature tests, for example, annealing at 260° C. for about 8 minutes, and washing tests, for example immersing the thin film battery in water at 70° C. for about 3 minutes, without any adverse effects on battery performance.

Still another advantage of this invention is that thin films of aluminum oxide and silicon dioxide are heat-resistant, inert dielectric materials and amorphous and thus do not react with the underlying thin film battery materials. In addition, aluminum oxide and silicon dioxide act as excellent diffusion barriers. Thus, when a layer of cured epoxy is added to the protective coating the thin film battery becomes completely impervious to fluids, for instance water.

Yet another advantage of this invention is that the composite protective coating is impervious to gases and fluids and thus, thin film batteries having this protective coating can be exposed to manufacturing processes such as, for instance, solder reflow and water rinse processes without experiencing any adverse effect on the performance of the thin film battery.

The foregoing is provided for purposes of illustrating, explaining and describing several embodiments of this invention. Modifications and adaptations to these embodiments will be apparent to those of ordinary skill in the art and may be made without departing from the scope or spirit of the invention and the following claims. Also, the embodiments described in this document in no way limit the scope of the below claims as persons skilled in this art recognize that this invention can be easily modified for use to provide additional functionalities and for new applications.

We claim:

1. A thin film battery having a protective coating that is heat-resistant and hermetically seals the thin film battery, comprising:
a. a substrate having a thin film deposited thereon including a cathode current collector, a cathode, an electrolyte, an anode and an anode current collector;
b. a first thin film layer of dielectric material selected from the group consisting of:
i. aluminum oxide;
ii. silicon dioxide;
iii. silicon nitride;
iv. silicon carbide;
v. tantalum oxide;
vi. diamond; and
vii. diamond-like-carbon;
c. a second thin film layer of dielectric material selected from the group consisting of
i. aluminum oxide;
ii. silicon dioxide;
iii. silicon nitride;
iv. silicon carbide;
v. tantalum oxide;
vi. diamond; and
vii. diamond-like-carbon; and
d. a sealing layer positioned over the second thin film layer and covering the entire thin film battery.

2. The thin film battery of claim 1, wherein the sealing layer further comprises epoxy.

3. The thin film battery of claim 2, wherein the epoxy is cured by an ultraviolet light and annealed at about 260° C. for about five minutes.

4. The thin film battery of claim 3, wherein the first thin film layer and the second thin film layers are annealed at about 260° C. for about six minutes.

5. The thin film battery of claim 1, wherein the sealing layer further comprises glow discharge polymerized silicon containing hydrophobic films.

6. The thin film battery of claim 1, wherein the sealing layer has a thickness between 0.1 and 5 microns.

7. The thin film battery of claim 1, wherein the diamond and diamond-like-carbon dielectric materials are deposited using a PECVD process.

8. A method of providing a protective coating for a thin film battery cell, comprising the steps of:
a. positioning a layer of aluminum oxide upon the thin film battery cell;
b. positioning a layer of silicon dioxide upon the layer of aluminum oxide; and
c. positioning a layer of epoxy upon the layer of silicon dioxide such that the layer of epoxy covers the entire thin film battery cell.

9. The method of claim 8, further comprising curing the layer of epoxy utilizing an ultraviolet light.

10. The method of claim 8, wherein the positioning a layer of aluminum oxide upon the thin film battery cell is performed using a sputtering process.

11. The method of claim 8, wherein the positioning a layer of silicon dioxide upon the layer of aluminum oxide is performed using a sputtering process.

12. The method of claim 9, further comprising annealing the thin film battery having the layers of aluminum oxide, silicon dioxide and cured epoxy at about 260° C. for about five minutes.

13. A method of providing a protective coating for a thin film battery cell, comprising the steps of:
a. positioning layers of a protective coating material upon the thin film battery cell, and
b. sealing the protective coating such that the resulting thin film battery cell having a protective coating is impervious to heat, moisture and atmospheric elements.

14. The method of claim 13, wherein the positioning layers of a protective coating material upon the thin film battery cell step is performed by positioning at least one layer of protective coating material having a thickness between 0.1 and 5 microns and is selected from the group consisting of aluminum oxide, silicon dioxide, silicon nitride, silicon carbide, tantalum oxide, diamond and diamond-like-carbon.

15. The method of claim 13, wherein the sealing the protective coating step further comprises spreading epoxy over the protective coating, curing the epoxy using an ultraviolet light and annealing cured epoxy.

16. The method of claim 13, wherein the positioning layers of a protective coating material upon the thin film battery cell step is performed by using a plasma enhanced chemical vapor deposition process.

17. The method of claim 13, wherein the positioning layers of a protective coating material upon the thin film battery cell step is performed by using a sputtering process.

18. The method of claim 13, further comprises annealing the layers of protective coating material at about 260° C. for about six minutes.

19. The method of claim 18, wherein the sealing the protective coating step further comprises spreading epoxy over the protective coating, curing the epoxy using an ultraviolet light and annealing cured epoxy.

20. A method of producing a thin film battery having a protective coating that is heat-resistant and hermetically sealed, comprising:
a. depositing at least one thin film layer of a dielectric material upon the thin film battery;
b. annealing the at least one thin film layer of dielectric material at about 260° C.;
c. covering the at least one thin film layer of dielectric material with an epoxy;
d. curing the epoxy using an ultraviolet light;
e. annealing the epoxy at about 260° C. for about six minutes.
